(19) United States
(12) Patent Application Publication
(10) Pub. No.: US 2008/0209190 A1
(43) Pub. Date: Aug. 28, 2008

(54) PARALLEL PREDICTION OF MULTIPLE BRANCHES

(75) Inventors: Ravindra N. Bhargava, Austin, TX (US); Brian Raf, Arlington, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/680,043

(22) Filed: Feb. 28, 2007

(51) Int. Cl. G06F 9/38

(52) U.S. Cl. 712/240

(57) ABSTRACT

A branch history value associated with a first branch instruction of a first set of instructions is determined. The branch history value represents a branch history of a program flow prior to the first branch instruction. A first branch prediction of the first branch instruction is determined based on the branch history value of the first branch instruction and a first identifier associated with first branch instruction. A second branch prediction of a second branch instruction of the first set of instructions based on the branch history value associated with the first branch instruction and a second identifier associated with the second branch instruction. The second branch instruction occurs subsequent to the first branch instruction in the program flow. A second set of instructions is fetched at the processing device based on at least one of the first branch prediction and the second branch prediction.

### FIELD OF THE DISCLOSURE

The present disclosure relates generally to program flow in a processing device and more particularly to branch prediction in a processing device.

### BACKGROUND

To increase instruction throughput at a processor with a relatively large fetch bandwidth, it typically is advantageous to predict multiple branch instructions within the same fetch window. However, many conventional branch predictor tables are indexed based on prior branch prediction history (i.e., a representation of previously encountered branches). Accordingly, to accurately predict whether a branch in a program flow is to be taken, all previous branches typically need to be predicted or resolved. Thus, in order to index with the most up-to-date branch history, multiple sequential accesses to the branch prediction table are needed in a typical branch prediction table having a single read port. In an effort to avoid these sequential accesses to obtain multiple branch predictions within the same fetch window, branch prediction tables with multiple read ports have been developed so that separate table entries can be accessed in parallel, whereby all possible combinations of branch history are used as indicia through the corresponding read ports. However, the implementation of branch prediction tables with multiple read ports significantly increases the complexity of the branch prediction scheme. Further, in both a conventional single read port implementation with sequential accesses and a multiple read port branch prediction table implementation with parallel accesses, more time is required to retrieve the prediction information from the tables and thus their use becomes counter-productive as either the clock period is increased to accommodate the increase in access time or the branch prediction turnaround throughput decreases. Accordingly, an improved technique for multiple branch prediction would be advantageous.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating an example processing device utilizing a multiple branch prediction scheme in accordance with at least one embodiment of the present disclosure.

FIG. 2 is a block diagram illustrating an example branch prediction/fetch module in accordance with at least one embodiment of the present disclosure.

FIG. 3 is a block diagram illustrating an example branch predictor module of the branch prediction/fetch module of FIG. 1 in accordance with at least one embodiment of the present disclosure.

The use of the same reference symbols in different drawings indicates similar or identical items.

### DETAILED DESCRIPTION

In accordance with one aspect of the present disclosure, a method includes determining, at a processing device, a branch history value associated with a first branch instruction of a first set of instructions. The branch history value represents a branch history of a program flow prior to the first branch instruction. The method further includes determining, at the processing device, a first branch prediction of the first branch instruction based on the branch history value of the first branch instruction and a first identifier associated with first branch instruction. The method additionally includes determining, at the processing device, a second branch prediction of a second branch instruction of the first set of instructions based on the branch history value associated with the first branch instruction and a second identifier associated with the second branch instruction. The second branch instruction occurs subsequent to the first branch instruction in the program flow. The method additionally including fetching a second set of instructions at the processing device based on at least one of the first branch prediction and the second branch prediction.

In accordance with another aspect of the present disclosure, a method includes determining, at a processing device, a first identifier associated with a first branch instruction of a first set of instructions and a second identifier associated with a second branch instruction of the first set of instructions. The second branch instruction occurs subsequent to the first branch instruction in a program flow. The method additionally includes determining, at the processing device, a branch history value representing a branch history of the program flow prior to the first branch instruction and indexing a first entry of a branch prediction table based on the branch history value. The first entry including a plurality of subentries. The method additionally including selecting a first subentry of the first entry of the branch prediction table based on the first identifier and selecting a second subentry of the second entry of the branch prediction table based on the second identifier in parallel with selecting the first subentry of the first entry. The method further including determining a first branch prediction for the first branch instruction based on a first value stored at the first subentry and determining a second branch prediction for the second branch instruction based on a second value stored at the second subentry. The method additionally includes fetching a second set of instructions based on at least one of the first branch prediction and the second branch prediction.

In accordance with yet another aspect of the present disclosure, a processing device includes a branch history table and a branch predictor module. The branch history table is to store a branch history value representative of a branch history of a program flow prior to a first branch instruction of a first set of instructions. The first set of instructions further comprises a second branch instruction occurring subsequent to the first branch instruction in the program flow. The branch predictor module is to determine a first branch prediction for the first branch instruction and a second branch prediction for the second branch instruction based on the branch history value, a first identifier associated with the first branch instruction, and a second identifier associated with the second branch instruction.

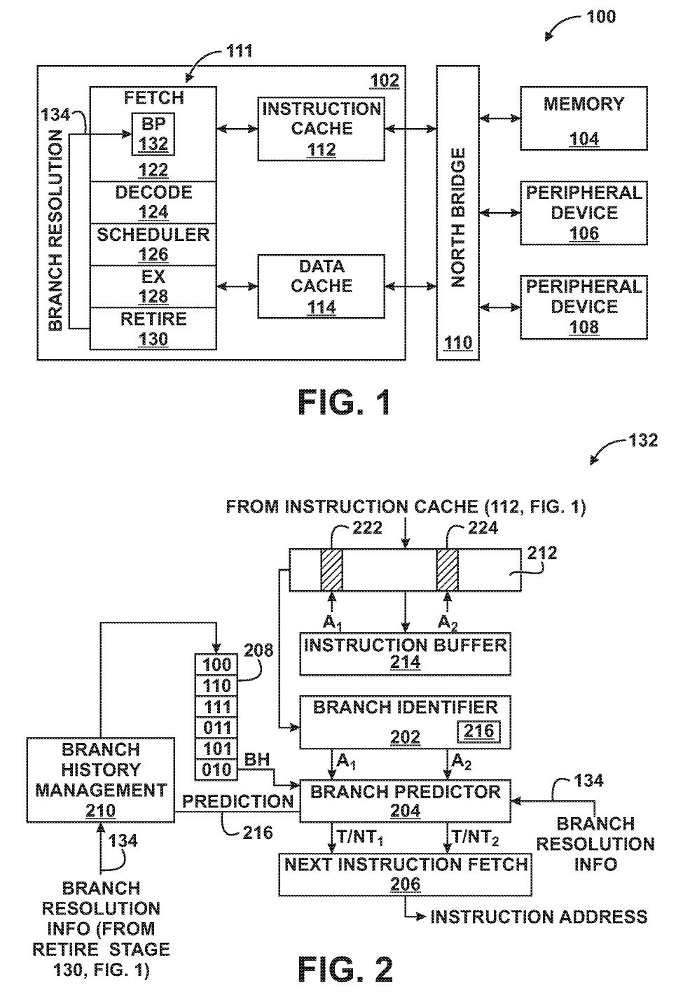

FIGS. 1-3 illustrate example techniques for predicting multiple branches within a given fetch window. In one embodiment, instruction data representing a set of sequential instructions is fetched for processing, whereby the set of sequential instructions includes two or more branch instructions. A branch history value is determined for the first branch instruction to occur within the program flow of the set of sequential instructions, whereby the branch history value represents a history (e.g., taken or not taken) of at least a portion of a sequence of branch instructions preceding the first branch instruction in the program flow from previously fetched sets of instructions. The branch history value for the first branch instruction is then used as an index into a branch prediction table so as to determine a prediction for the first branch instruction. Further, the branch history value of the first branch instruction is also used as an index into the branch prediction table so as to determine a prediction for each branch instruction of the set of sequential instructions that follows the first branch instruction in the program flow. Thus, by using the branch history value of the initial branch instruction to occur in a sequence of instructions to index into a branch prediction table for both the initial branch instruction and one or more subsequent branch instructions, predictions for multiple branch instructions that occur sequentially in the sequence of instructions can be determined in parallel without requiring the resolution of the branch prediction of the preceding branch instruction.

In one embodiment, each entry of the branch prediction table includes a plurality of subentries, each subentry storing a value representing a branch prediction, whereby the branch history value of the first branch instruction is used to index a particular entry. From the particular entry, two or more subentries can be accessed in parallel based on indices based on identifiers associated with the branch instructions being predicted, such as, for example, part or all of the instruction addresses of the branch instructions. In one embodiment, the index used to select a particular subentry is based on a hash function of a subset of the branch history value of the first branch instruction of the set of sequential instructions and a subset of the instruction address associated with the branch instruction of the set of sequential instructions that is being predicted.

FIG. 1 illustrates an example processing device 100 in accordance with at least one embodiment of the present disclosure. The processing device 100 can include, for example, a microprocessor, a microcontroller, an application specific integrated circuit (ASIC), and the like.

In the depicted example, the processing device 100 includes a processor 102, a memory 104 (e.g., system random access memory (RAM)), and one or more peripheral devices (e.g., peripheral devices 106 and 108) coupled via a northbridge 110 or other bus configuration. The processor 102 includes an execution pipeline 111, an instruction cache 112, and a data cache 114. Instruction data representative of one or more programs of instructions can be stored in the instruction cache 112, the memory 104, or a combination thereof. The execution pipeline 111 includes a plurality of execution stages, such as an instruction fetch stage 122, an instruction decode stage 124, a scheduler stage 126, an execution stage 128, and a retire stage 130. Each of the stages may be implemented as one or more substages.

In one embodiment, the fetch stage 122 is configured to fetch a block of instruction data from the instruction cache 112 in accordance with the program flow, whereby the block of instruction data comprises instruction data representative of a plurality of sequential instructions (hereinafter referred to as the “fetch set”). The fetch stage 122 then provides some or all of the instruction data to the decode stage 124, whereupon the instruction data is decoded to generate one or more instructions. The one or more instructions then are provided to the scheduler stage 126, whereupon they are scheduled for execution by the execution stage 128. The results of the execution of an instruction are stored at a re-order buffer or register map of the retire stage 130 pending resolution of any preceding branch predictions.

In at least one embodiment, the program or programs of instructions being executed at the processing device 100 include branch instructions (e.g., conditional branch instructions or unconditional branch instructions) that have the potential to alter the program flow depending on whether the branch is taken or not taken. Depending on the frequency and number of branch instructions within an executed program, the fetch set fetched from the instruction cache 112 can include one or more branch instructions. In order to expedite execution, the fetch stage 122 includes a branch prediction/fetch module 132 configured to identify branch instructions within a fetch set, predict in parallel whether the identified branch instructions are taken or not taken based on information stored in a branch prediction table, and configure the fetch stage 122 to fetch the next fetch set from the instruction cache 112 based on the one or more branch predictions made for the fetch set.

The retire stage 130 is configured to feed back branch resolution information 134 representative of the resolution result (taken or not taken) for branch predictions made by the branch prediction/fetch module 132, whereupon the branch prediction/fetch module 132 can refine its branch prediction tables based on the branch resolution information 134.

FIG. 2 illustrates an example implementation of the branch prediction/fetch module 132 in accordance with at least one embodiment of the present disclosure. In the depicted example, the branch prediction/fetch module 132 includes a branch identifier module 202, a branch predictor module 204, a next instruction fetch module 206, a branch history table 208, and a branch history management module 210.

The branch identifier module 202, in one embodiment, is configured to identify the presence of branch instructions within a fetch set (e.g., fetch set 212) obtained from the instruction cache 112 (FIG. 1). The branch identifier module 202 can identify branch instructions based on, for example, opcodes within the fetch set that are associated with branch instructions. In one embodiment, the branch identifier module 202 scans a fetch set for branch instructions the first time the fetch set is fetched from the instruction cache 112 and stored in an instruction buffer 214 of the fetch stage 122 (FIG. 1). The branch identifier module 202 then creates an entry in a branch identifier table 216 for each identified branch instruction in the fetch set (with the number of entries in the branch identifier table 216 being constrained by the size of the table 216). In an alternate embodiment, the instruction decode components at the decode stage 124 (FIG. 1) can identify branch instructions and provide the information to the branch identifier module 202 for entry into the branch identifier table 216. In another embodiment, the branch history management module 210 provides the branch identifier information for storage into the branch identifier table 216.

The entry in the branch identifier table 216 can include, for example, the instruction address of the branch instruction, the type of branch instruction, and the like. Thus, for subsequent fetches of the same fetch set, or a portion thereof, rather than having to rescan the entire fetch set to identify any branch instructions contained therein, the branch identifier module 202 instead can use the instruction address(es) associated with the fetch set as indices to the branch identifier table 216 to determine whether any branch instructions are present in the fetch set.

The branch history table 208 includes a plurality of first-in, first-out (FIFO) entries. Each entry comprises a bit vector or other value representative of at least a portion of the branch history of the program flow as made by the branch prediction/fetch module 132 such that the sequence of bit vectors or values in the entries of the branch history table 208 represents the sequence of branch results in the program flow. In the illustrated example, each entry stores a three-bit vector, whereby a value of “1” at any bit position of the bit vector indicates a corresponding branch in the branch history was taken and a value of “0” indicates a corresponding branch in the branch history was not taken. However, while a three-bit vector is illustrated for ease of discussion, it will be appreciated that larger bit vectors or alternate representations of a branch history can be implemented so as to provide a more detailed representation of the prior branch history.

In one embodiment, the branch history management module 210 is configured to add entries to the branch history table 208 based on branch predictions made by the branch predictor module 204 and to modify or remove entries from the branch history table 208 based on the branch resolution information 134 received from the retire stage 130 (FIG. 1) with respect to branch predictions made by the branch predictor module 204. When a branch prediction is made by the branch predictor module 204, the branch predictor module 204 sends a prediction signal 216 to the branch history management module 210, whereby the state of the prediction signal 216 indicates whether the branch prediction is predicted taken (e.g., a “1”) or predicted not-taken (e.g., a “0”). In response to the prediction signal 216, the branch history management module 210 obtains a copy of the bit vector in the last (most recent) entry of the branch history table 208 and shifts the bit value of the prediction signal 216 into the copy. To illustrate, assuming that the rightmost bit of a bit vector represents the least recent branch of the represented branch history and the leftmost bit of the bit vector represents the most recent branch, the branch history management module 210 can right shift the copy of the bit vector and then append the bit value of the prediction signal 216 in the leftmost bit position of the bit vector. For example, assume that the last entry in the branch history table includes a bit vector of “100”, which indicates that the most recent branch at that time was taken and the two preceding branches were not taken. In response to the branch predictor module 204 predicting that the next branch in the program flow is taken, and thus sending a “1” as the prediction signal 216, the branch history management module 210 copies the bit vector “100” from the last entry, shifts it right one bit, and appends the “1” of the prediction signal 216 to generate the bit vector “110”, which is then pushed into the last entry of the branch history table 208. Thus, because the entry was created in response to a branch prediction by the branch predictor module 204, some or all of the branch history entries of the branch history table 208 may be speculative until resolution of the corresponding branch predictions occur. In an alternate embodiment, the branch predictor module 204 maintains a copy of the speculative branch history and then sends a copy of one or more of the entries to the branch history table 208 upon resolution of the branch predictions.

It will be appreciated that the branch predictor module 204 may mispredict branches in the program flow. Accordingly, upon receipt of branch resolution information 134 that indicates that a branch was mispredicted, the branch history management module 210 modifies the bit vectors of the branch history entries that are affected by the misprediction. In one embodiment, the modification includes removing from the branch history table 208 any of the entries that are no longer accurate due to the misprediction.

In one embodiment, the branch predictor module 204 determines a prediction for each branch instruction of a fetch set in parallel by accessing a branch history value from the branch history table 208 that represents the branch results (e.g. taken/not taken) for a series of branches in the program flow leading up to the first branch instruction in the fetch set. The branch predictor module 204 then determines a branch prediction for each branch instruction in the fetch set using the branch history associated with the first branch instruction of the fetch set with respect to the program flow. As described in greater detail herein, the branch predictor module 204 utilizes a branch predictor table with multiple entries indexable via, for example, the branch history value from the latest entry of the branch history table 208, whereby each entry includes a plurality of subentries that store prediction information. Thus, one branch history value can be used to index multiple branch prediction values corresponding to a number of sequential branch instructions of a fetch set. Select ones of the multiple branch prediction values then can be accessed in parallel using identifiers associated with the respective branch instructions of the fetch set. The branch predictor module 204 then determines the branch prediction for each branch instruction of the fetch set based on the accessed branch prediction values.

For each branch prediction made, the branch predictor module 204 provides a branch prediction signal 216 as described above. As noted above, the branch predictor module 204 may correctly or incorrectly predict branches. Accordingly, in at least one embodiment, the branch predictor module 204 receives the branch resolution information 134 from the retire stage 130 and updates the corresponding prediction subentries of the branch predictor table to reflect the actual branch results. As described in greater detail herein, the prediction in each entry can include a value representative of the prediction (taken or not taken), as well as value representative of the prediction strength (e.g., weak or strong). Accordingly, when the branch predictor module 204 is informed by the branch resolution information 134 that it has mispredicted a branch, the branch predictor module 204 updates the corresponding subentry associated with the branch by, for example, changing the strength of the prediction, changing the prediction, or a combination thereof.

The next instruction fetch module 206 is configured to determine the next instruction address associated with the next fetch set to be fetched from the instruction cache. The next instruction fetch module 206, in one embodiment, determines the next instruction address based on each branch prediction made by the branch predictor module 204 for each branch instruction in the fetch set currently being processed. To illustrate, assume that the fetch set 212 includes two branch instructions, branch instruction 222 and branch instruction 224. In the event that the branch predictor module 204 predicts branch instruction 222 as taken, the next instruction fetch module 206 calculates the branch target address of the branch instruction 222 utilizing any of a variety of techniques as appropriate. Alternately, in the event that the branch predictor module 204 predicts branch instruction 222 is not taken and the branch instruction 224 is taken, the next instruction fetch module 206 calculates the branch target address of the branch instruction 224. In the event that neither is predicted as taken, the next instruction fetch module 206 calculates the next instruction address based on, for example, a sequential incrementation of the program counter (PC).

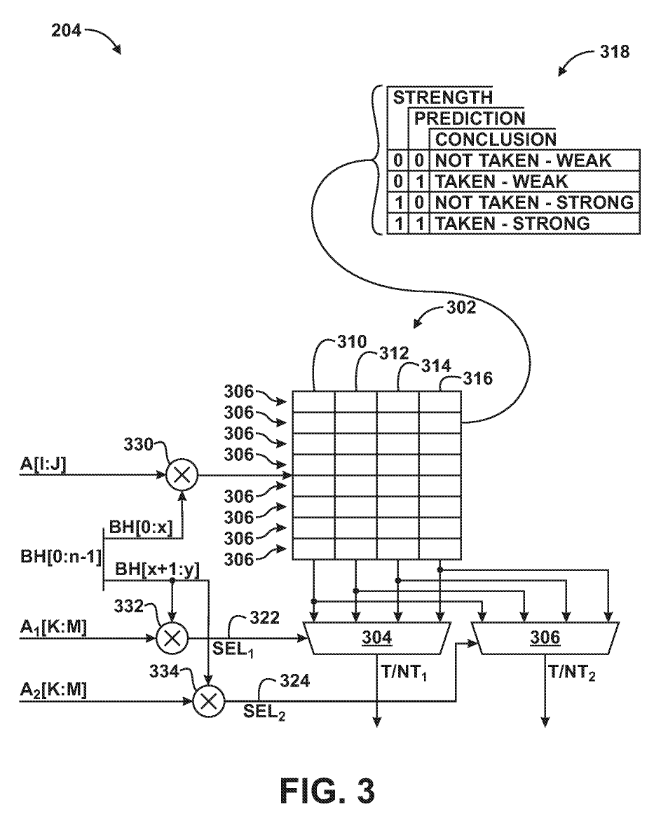

FIG. 3 illustrates an example implementation of the branch predictor module 204 of the branch prediction/fetch module 132 in accordance with at least one embodiment of the present disclosure. In the illustrated example, it is assumed for clarify purposes that any given fetch set (e.g., fetch set 212, FIG. 2) includes at most two branch instructions and thus the branch predictor module 204 is configured to predict at most two sequential branches in parallel for any given fetch set. However, it will be appreciated that the number of potential branch instructions in a fetch set depends at least in part on the bandwidth of the fetch set (i.e., the number of instructions that can be represented by the fetch set) and thus the illustrated implementation can be expanded to support parallel prediction of more than two branch instructions per fetch set.

In the depicted example, the branch predictor module 204 includes a branch predictor table 302, a multiplexer 302, and a multiplexer 304. The branch predictor table 302 includes a plurality of entries 306, each entry 306 including a plurality of subentries. In the illustrated example, each entry 306 includes four subentries: subentry 310, subentry 312, subentry 314, and subentry 316 (hereinafter, “subentries 310-316”). It will be appreciated in implementations that support the prediction or more than two branch instructions within a fetch set, more than two multiplexers may be utilized. Further, although the illustrated example depicts four subentries per entry 306, the number of subentries per given entry 306 can be of variable size depending upon implementation.

Each subentry comprises one or more bits representative of a branch prediction. As illustrated by key 318, each subentry includes two bits, whereby the first bit value represents a strength of the prediction (e.g., “0” indicating a weak prediction and “1” indicating a strong prediction) and the second bit value represents the prediction (e.g., “0” indicating a not taken prediction and “1” indicating a taken prediction). The two bit values of each subentry are adjusted based on the resolution of predictions of branches that index or otherwise are associated with the entry. To illustrate, when the branch predictor module 204 correctly predicts a branch, the subentry mapped to the branch can be modified to represent an increase in the strength of the prediction. This can include, for example, switching the first bit value from a “0” to a “1” to reflect an increase in the strength in the prediction. Conversely, when the branch predictor module 204 incorrectly predicts a branch, the subentry mapped to the branch can be modified to represent a decrease in the strength of the prediction (e.g., switching the first bit value from a “1” to a “0” to reflect a decrease in the strength in the prediction) or if the strength of the prediction is already weak, the subentry can be modified so that the opposite prediction is then represented by the subentry (e.g., by switching the two-bit value from a “01” to a “00” to reflect a change in the prediction from a weak prediction of taken to a weak prediction of not taken).

In one embodiment, the entries 306 of the branch prediction table 302 are indexed using some or all of the bits of the least recent entry of the branch history table 208 (i.e., the branch history of the program flow leading up to the first branch instruction in the fetch set being processed), using a set of bits of the instruction addresses A1 and A2 common to both instruction addresses (e.g., the same page number, or a combination thereof. In FIG. 3, the index into the branch prediction table 302 is generated using hash logic 330, which performs a hash operation using the values BH[0:n−1] and A[I:j], where BH[0:n−1] is the bit vector that represents the branch history value in the branch history table 208 (FIG. 2), x is equal to or less than the total number of bits n of the bit vector, and BH[0:x] represents the portion of the bits of the branch history bit vector used to index one of the entries 306, and A[i:j] represents the set of bits common to both instruction addresses A1 and A2. Thus, the entries 306 are indexed by at least a portion of the branch history leading up to the first branch instruction in the sequence of instructions of the fetch set being processed. In an alternate embodiment, a portion or all of the branch history value BH can be used without the instruction address values to generate an index value for the branch prediction table 302.

As illustrated in FIG. 3, each of the subentries 310-316 of an indexed entry 306 is mapped to a corresponding input of the multiplexer 304 and a corresponding input of the multiplexer 306. The multiplexer 304 includes a control input configured to receive a select signal (SEL1) 322, whereby the multiplexer 304 selects as an output the prediction bit (taken/not taken or T/NT₁) of one of the subentries 310-316 of an indexed entry 306 based on the select signal 322. Similarly, the multiplexer 306 includes a control input configured to receive a select signal (SEL2) 324, whereby the multiplexer 306 selects as an output the prediction bit (taken/not taken or T/NT₂) of one of the subentries 310-316 of the indexed entry 306 based on the select signal 324. Thus, by connecting each of the subentries 310-316 to both the multiplexer 304 and the multiplexer 306, more than one of the subentries 310-316 can be accessed in parallel at the same time (i.e., within the same clock cycle) without requiring multiple read ports.

In one embodiment, the select signals 322 and 324 are generated based on the branch history leading up to the first branch instruction in the fetch set being processed (as represented by, for example, the bit vector BH), and an identifier associated with a respective on of the two branch instructions 222 and 224 (FIG. 2), identified by the branch identifier module 202 as being resident in the fetch set being processed. The identifier for each branch instruction can include, for example, at least a portion of the instruction address of the branch instruction, an opcode associated with the branch instruction, a type of branch instruction, and the like. In the depicted example, the branch predictor module 204 includes hash logic 332 to generate the select signal 322 and hash logic 334 to generate the select signal 324. The hash logic 332 performs a hash operation using a portion of the bits of the branch history bit vector (e.g., BH[x+1:y], where y is less than or equal to n−1) and a portion of the bits of the address value A₁ (A₁[k:m]) (as an identifier associated with the branch instruction 222) to generate the select signal 322. Similarly, the hash logic 334 performs a hash operation using the same portion of the bits of the branch history bit vector (BH[x+1:y]) and a corresponding portion of the bits of the address value A₂ (A₂[k:m]) (as an identifier associated with the branch instruction 222) to generate the select signal 324. In one embodiment, the values A₁[k:m] and A₂[k:m] are different from each other by at least one bit value.

Thus, as the implementation of FIG. 3 illustrates, the branch history leading up to the first branch instruction to occur in the sequence of instructions of the fetch set can be used to access a branch prediction table for some or all branch instructions of the fetch set without requiring resolution of the branch prediction for the first branch instruction of the fetch set or without requiring multiple read ports to access a branch prediction table using every possible permutation of branch results following the first branch instruction. Thus, while the original branch history would not be current for the second and subsequent branch instructions within the fetch set, there is an implicit not-taken branch history embedded in the indexing scheme. Therefore, the hash-based indexing for all branch instructions subsequent to the first branch instruction in the fetch set will always find the same subentry of the branch prediction table 302 when reached via the same path, thereby providing a robust and reliable prediction scheme. Further, by utilizing multiple multiplexers to access subentries of an entry indexed based on the same branch history common to all branches of the sequence of instructions in the fetch set, branch predictions for all branches in the sequence of instructions of the fetch set can be determined in the same clock cycle, thereby increasing instruction-per-cycle throughput at the processing device.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
determining, at a processing device, a branch history value associated with a first branch instruction of a first set of instructions, the branch history value representing a branch history of a program flow prior to the first branch instruction;
determining, at the processing device, a first branch prediction of the first branch instruction based on the branch history value of the first branch instruction and a first identifier associated with first branch instruction;
determining, at the processing device, a second branch prediction of a second branch instruction of the first set of instructions based on the branch history value associated with the first branch instruction and a second identifier associated with the second branch instruction, the second branch instruction occurring subsequent to the first branch instruction in the program flow; and
fetching a second set of instructions at the processing device based on at least one of the first branch prediction and the second branch prediction.

2. The method of claim 1, wherein the set of instructions comprises a set of sequential instructions.

3. The method of claim 1, wherein the branch history value comprises a bit vector that represents at least a portion of the branch history of the program flow.

4. The method of claim 1, wherein determining the second branch prediction comprises determining the second branch prediction in parallel with determining the first branch prediction.

5. The method of claim 4, wherein the first branch prediction and the second branch prediction are determining within the same clock cycle of the processing device.

6. The method of claim 1, wherein:
the first identifier comprises a first instruction address associated with the first branch instruction; and
the second identifier comprises a second instruction address associated with the second branch instruction.

7. The method of claim 1, wherein:
determining the first branch prediction of the first branch instruction comprises determining a first value stored at a first location of a branch prediction table, the first value being representative of the first branch prediction and the first location being identified based on the branch history value of the first branch instruction and the first identifier; and
determining the second branch prediction of the second branch instruction comprises determining a second value stored at a second location of the branch prediction table, the second value being representative of the second branch prediction and the second location being identified based on the branch history value of the first branch instruction and the second identifier.

8. The method of claim 7, wherein determining the second value comprises determining the second value in parallel with determining the first value.

9. The method of claim 7, wherein the first location comprises a first subentry of an entry of the branch prediction table and the second location comprises a second subentry of the entry of the branch prediction table, the entry of the branch prediction table being indexed in the branch prediction table based on a first portion of the prediction history value hashed with a portion of at least one of the first identifier and the second identifier, the first subentry being indexed in the entry based on a second portion of the prediction history value and at least a portion of the first identifier, and the second subentry being indexed in the entry based on the second portion of the prediction history value and at least a portion of the second identifier.

10. The method of claim 9, wherein:
the first subentry is indexed based on a first hash operation using the second portion of the prediction history value and at least a portion of the first identifier; and
the second subentry is indexed based on a second hash operation using the second portion of the prediction history value and at least a portion of the second identifier.

11. A method comprising:
determining, at a processing device, a first identifier associated with a first branch instruction of a first set of instructions and a second identifier associated with a second branch instruction of the first set of instructions, the second branch instruction occurring subsequent to the first branch instruction in a program flow;
determining, at the processing device, a branch history value representing a branch history of the program flow prior to the first branch instruction;
indexing a first entry of a branch prediction table based on the branch history value, the first entry comprising a plurality of subentries;
selecting a first subentry of the first entry of the branch prediction table based on the first identifier;
selecting a second subentry of the second entry of the branch prediction table based on the second identifier in parallel with selecting the first subentry of the first entry;
determining a first branch prediction for the first branch instruction based on a first value stored at the first subentry;
determining a second branch prediction for the second branch instruction based on a second value stored at the second subentry; and
fetching a second set of instructions based on at least one of the first branch prediction and the second branch prediction.

12. The method of claim 11, wherein:
the first identifier comprises a first instruction address associated with the first branch instruction; and
the second identifier comprises a second instruction address associated with the second branch instruction.

13. The method of claim 12, wherein the branch history value comprises a bit vector that represents at least a portion of the branch history.

14. The method of claim 13, wherein:
indexing the entry of the branch prediction table comprises indexing the entry based on a first hash operation using a first portion of the bit vector and a portion of at least one of the first instruction address and the second instruction address;
indexing the first subentry of the entry of the branch prediction table comprises indexing the first subentry based on a second hash operation using a second portion of the bit vector and at least a portion of the first instruction address; and
indexing the second subentry of the entry of the branch prediction table comprises indexing the second subentry based on a third hash operation using the second portion of the bit vector and at least a portion of the second instruction address.

15. A processing device comprising:
a branch history table to store a branch history value representative of a branch history of a program flow prior to a first branch instruction of a first set of instructions, the first set of instructions further comprising a second branch instruction occurring subsequent to the first branch instruction in the program flow; and
a branch predictor module to determine a first branch prediction for the first branch instruction and a second branch prediction for the second branch instruction based on the branch history value, a first identifier associated with the first branch instruction, and a second identifier associated with the second branch instruction.

16. The processing device of claim 15, wherein:
the first identifier comprises a first instruction address associated with the first branch instruction; and
the second identifier comprises a second instruction address associated with the second branch instruction.

17. The processing device of claim 15, wherein the branch history value comprises a bit vector that represents at least a portion of the branch history.

18. The processing device of claim 15, wherein the branch predictor module comprises:
a branch prediction table comprising a plurality of entries indexable based the branch history value, each of the plurality of entries comprising a plurality of subentries;
a first multiplexer comprising a first plurality of data inputs, each data input coupleable to a corresponding subentry of an indexed entry of the branch prediction table, a selection input configured to receive a first control value based on at least a portion of the first identifier, and an output to provide a first prediction value representative of the first branch prediction that is selected from the first plurality of data inputs based on the first control value; and
a second multiplexer comprising a second plurality of data inputs, each data input coupleable to a corresponding subentry of the indexed entry of the branch prediction table, a selection input configured to receive a second control value based on at least a portion of the second identifier, and an output to provide a second prediction value representative of the second branch prediction that is selected from the second plurality of data inputs based on the second control value.

19. The processing device of claim 18, wherein the first multiplexer and the second multiplexer are configured to output the first prediction value and the second prediction value in parallel.

20. The processing device of claim 18, further comprising:
first hash logic configured to perform a first hash operation using a portion of the branch history value and at least a portion of the first identifier to generate the first control value; and
a second hash logic to perform a second hash operation using the portion of the branch history value and at least a portion of the second identifier.
